(19) United States
(12) Patent Application Publication
(10) Pub. No.: US 2015/0357135 A1
(43) Pub. Date: Dec. 10, 2015

(54) CIRCUIT BREAKER PROVIDED WITH MEANS THAT REDUCE THE SWITCHING ARC BETWEEN PERMANENT CONTACTS

(71) Applicant: ALSTOM TECHNOLOGY LTD, Baden (CN)

(72) Inventors: Olivier Grejon, Parcieux (FR); Jean-Baptiste Jourjon, Chambery (FR)

(21) Appl. No.: 14/762,662

(22) PCT Filed: Jan. 27, 2014
(86) PCT No.: PCT/EP2014/051535

§ 371 Date: Jul. 22, 2015

(30) Foreign Application Priority Data
Jan. 29, 2013 (FR) 1350756

(51) Int. Cl. H01H 33/12

(52) U.S. Cl. CPC H01H 33/121

(57) ABSTRACT

A movable permanent contact (4) is made up of two portions (8, 11) separated by a dielectric spacer (12) and in communication with the electrical terminal (6) by means of respective rings of contacts (9, 10). The current flows mainly in the front ring (10) and the end of the portion (8) in normal operation. When the circuit breaker opens, the connection ceases, the current passes via the arcing contacts (2, 5), and the switching arc that appears briefly between contact portions (8 and 10) is confined in a step (14) and advantageously by a dielectric cap, thereby sparing the most sensitive portions of the volume between terminals, where the electrical field is the most intense.

The invention is a circuit breaker (or a switch) provided with means for reducing a switching arc appearing between the permanent contacts and for reducing its effects.

The circuit breakers under consideration here have first contacts connected to one electrical terminal and second contacts connected to another terminal, the second contacts being movable relative to the first in such a manner as to authorize open or closed positions of the circuit breaker. In addition, each contact presents both a contact referred to as a “permanent contact” and also an arcing contact, arranged in such a manner that, during a disconnection, the permanent contacts separate first and the current is then transferred to the arcing contacts, which separate next. However, an electric arc forms between the arcing contacts and remains for an instant, before being extinguished by means that are known in the art, and in particular by blasting.

The damage due to electric arcs (erosion and projection of melted matter) therefore essentially affects the arcing contacts, whereas the permanent contacts, in which most of the current flows during normal operation due to their much lower impedance, must remain more or less intact in order to maintain an appropriate state of the circuit breaker. However, that is not completely true in reality, since another electric arc, referred to as a switching arc, nevertheless appears between the permanent contacts upon their separation, because of the higher impedance of the arcing contacts that prevents complete switching of the current onto them. The damage caused by the switching arc is present on the permanent contacts, at the base of the arc, and also on the adjacent surfaces of the circuit breaker, with the drawback that those surfaces are in the space between terminals, which is subjected to the strongest electrical fields, and which ought therefore to retain a good surface state and cleanliness, without roughness, cavities, or ridges that degrade the dielectric strength of the circuit breaker.

A main object of the invention is therefore to reduce or to eliminate the effects of the switching arc. The object is achieved by a general form of the invention that provides a circuit breaker or switch comprising a first permanent contact and a first arcing contact and also a second permanent contact and a second arcing contact, the second contacts being movable relative to the first contacts in such a manner that, during switching or circuit-breaking movements, the permanent contacts separate from each other before the arcing contacts, the second contacts being linear and extending in the direction of the movements, and the second permanent contact being placed between the first permanent contact and the arcing contacts, sliding contacts, which are stationary relative to the first contacts, being in electrical connection with the second contacts, the circuit breaker or switch being characterized in that the second permanent contact includes a nose end directed towards the first contacts and separated from a main portion of the second permanent contact by a spacer that electrically insulates said nose end and said main portion from each other, the sliding contacts are subdivided into a first portion connected to the main portion of the second permanent contact and a second portion connected to the nose end of the second permanent contact, the first permanent contact is suitable for being electrically connected with only the nose end of the second permanent contact, and the nose end includes a step at a rear portion, so that, during said switching or circuit-breaking movements, the second portion of the sliding contacts is separated from the nose end before the first permanent contact.

The switching arc deploys in a space that is confined by the nose portion and it remains at a distance from the first permanent contact, from the second portion of the permanent contact that serves to establish the connection therewith, and from surrounding volumes of the circuit breaker, which volumes are subjected to the strongest electrical fields and have surfaces that must therefore be protected. The effects of the arc are increasingly reduced with increasing length of the nose end, and in particular if said end extends as far as an end of the second arcing contact. Likewise, a dielectric cap may extend between the first permanent contact and the second portion of the sliding contacts, so as to confine the switching arc even better, in particular relative to the first permanent contact.

In addition, better operation is obtained if the circuit breaker comprises a potential-setting contact disposed between the first and second portions of the sliding contacts, so as to establish an electrical connection with the nose end after the first permanent contact has separated from the second permanent contact during said switching or circuit-breaking movements, and set it to the potential of a terminal.

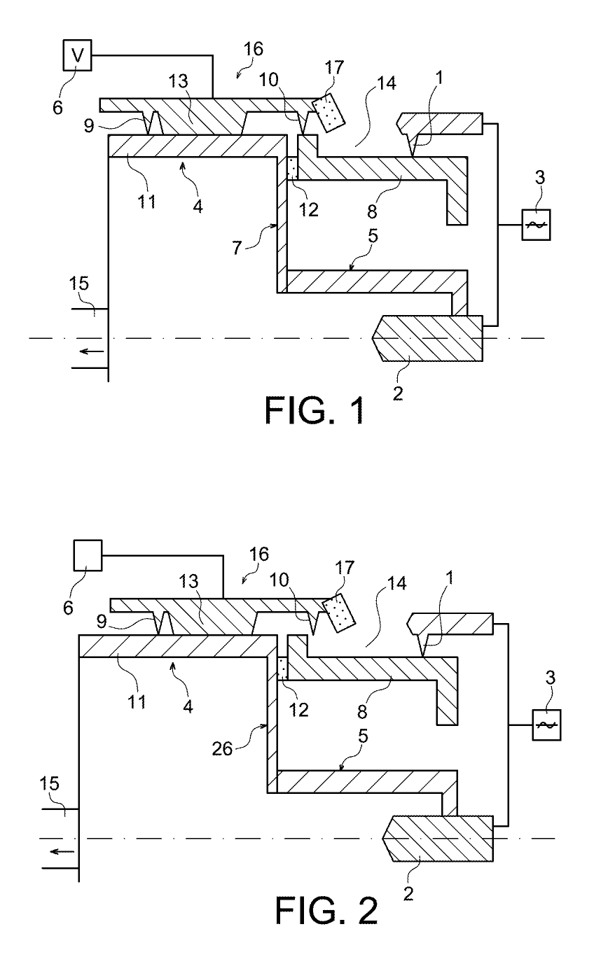

The invention is described below in connection with the following FIGS. 1, 2, 3, 4, and 5, which show a particular and non-exclusive embodiment of the invention and its operation between a closed state and successive open states of the circuit breaker.

FIG. 1 shows the main portions of a circuit breaker constituting the invention in a closed state. A first contact comprises a first permanent contact 1 and a first arcing contact 2, which in this embodiment are stationary and connected to a first electrical terminal 3. The circuit breaker further comprises second contacts including a second permanent contact 4 and a second arcing contact 5 connected to a second electrical terminal 6. The circuit breaker is generally a body of revolution and the contacts are therefore circular, mutually coaxial, and generally cylindrical. The first arcing contact 2 is a male contact in the shape of a rod at the center of the switchgear; the second arcing contact 5 is cylindrical and surrounds the first in such a manner as to be capable of forming an electrical connection therewith; the second permanent contact 4, which is also cylindrical, surrounds the second arcing contact 5 and supports it via an electrically-conductive flange 7; and the first permanent contact 1 surrounds an end of the nose 8 of the second permanent contact 4 and is capable of forming an electrical connection therewith. The first permanent contact 1 is a ring of contacts sliding on the cylindrical nose end 8 and is capable of being deformed. The switchgear further comprises other rings of sliding contacts that connect the second terminal 6 to the second permanent contact 4, having a rear ring of contacts 9 that is in permanent electrical connection with a main portion 11 of the second permanent contact 4, behind the nose end 8 and that carries the flange 7, and an auxiliary ring of contacts 10, potentially establishing an electrical connection with the nose end 8.

A dielectric spacer 12 electrically separates the nose end 8 from the main portion 11 of the first permanent contact 4 while at the same time connecting them together mechanically; a potential-setting contact 13 for setting the potential of the terminal 6 extends between the rear and auxiliary rings of contacts 9 and 10 and is capable of forming an electrical connection with the nose end 8 in states of the switchgear other than the state that is shown; and the nose end 8 has a step 14, i.e. a narrowing of its section at its front portion: the first permanent contact 4 establishes the electrical connection by sliding in the step 14, but the auxiliary ring of contacts 10 and the potential-setting contact 13 establish the electrical connection with a rear portion of the nose end 8 adjacent to the spacer 12 and outside the step 14.

The second contacts 4 and 5 are movable and may be moved towards the left of FIG. 1 in order to establish an electrical disconnection of the circuit breaker, starting from the connection state, (as shown in this figure), by pulling a drive rod 15 along the axis of the circuit breaker. A ring 16, which is shown only diagrammatically serves to support the rings of sliding contacts 9, 10 and the potential-setting contact 13 and to put them at the same potential since said ring 16 is electrically conductive. The ring further comprises a dielectric cap 17 projecting radially inwards and that extends in the step 14 between the first permanent contact 1 and the auxiliary ring 10.

Disconnection of the circuit breaker is described below starting from the state shown in FIG. 1. Disconnection consists in a progressive movement of the movable contacts 4 and 5. The components of the circuit breaker are arranged in such a manner that the first change in state is a disconnection between the nose end 8 and the auxiliary ring of contacts 10, which is shown in FIG. 2. A switching arc appears between the nose portion 8 and the auxiliary ring of contacts 10, but its effects are reduced since the arc is confined in the step 14 and does not reach the space between the terminals of the circuit breaker, at the front of the nose end 8, where its effects would be more pronounced. The dielectric cap 17 completes this confinement by obstructing the volume the arc can occupy towards the front of the second permanent contact 4. As in known devices, the electric current is quickly switched to the arcing contacts 2 and 5, which remain connected to each other, and the switching arc therefore ends up by being extinguished.

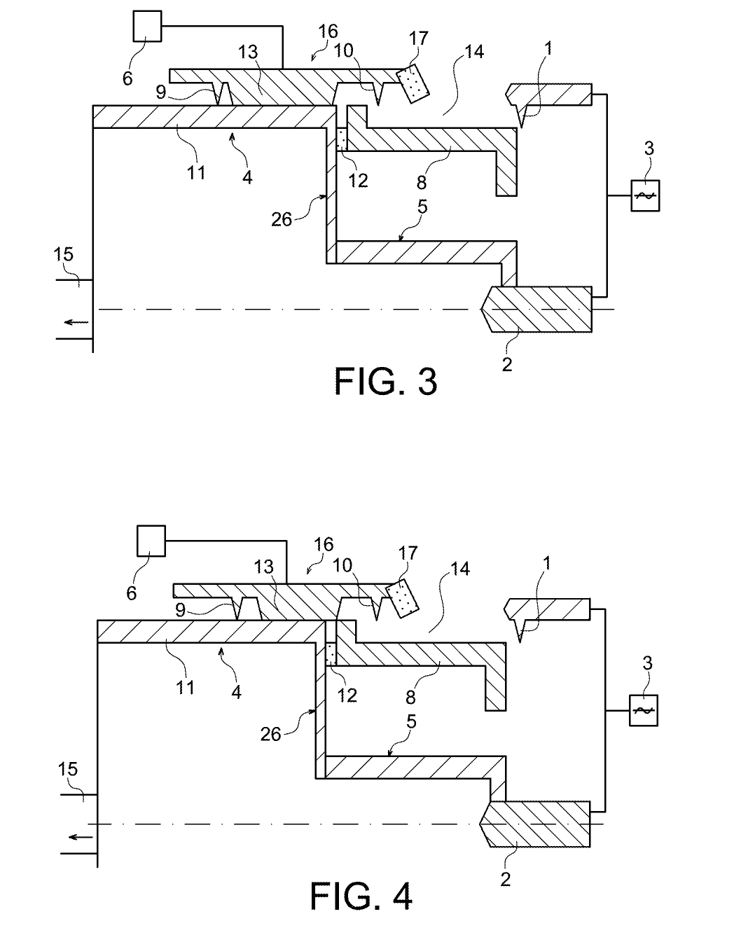

The second step is a disconnection of the first permanent contact 1 and the nose end 8, shown in FIG. 3. Since the switching arc is extinguished, the disconnection leaves the nose end 8 at a floating potential, since it is supported only by the dielectric spacer 12. Contrary to known designs, the switching arc therefore does not extend from the first permanent contact, which is located in the space between separated terminals.

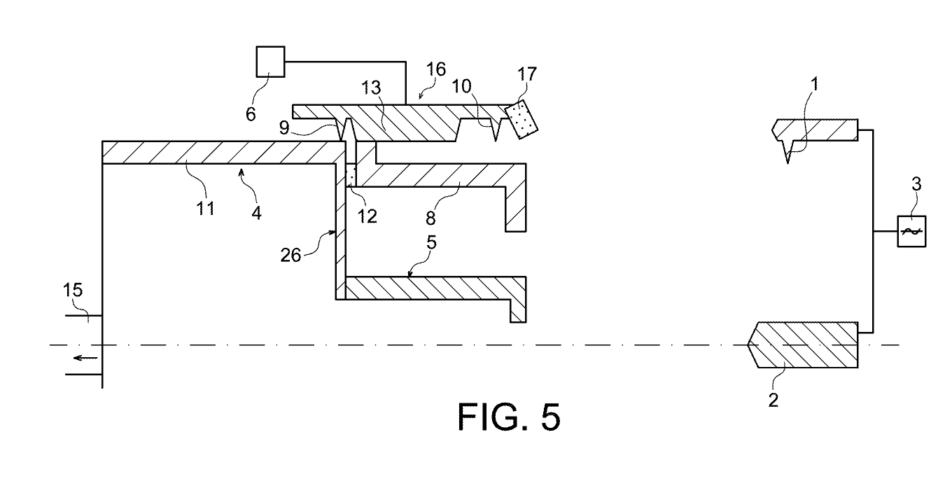

The following step is shown in FIG. 4 and consists in re-establishing an electrical connection between the nose end 8 and the second electrical terminal 6 via the potential-setting contact 13, which reaches the rear portion of the nose end 8. The second switching contact 4 is therefore set to the same potential. The current continues to flow between the terminals 3 and 6 via the arcing contacts 2 and 5, until the continuing movement of the rod 15 disconnects them. The fully open position of the circuit breaker is shown in FIG. 5. An electric arc is formed in known manner between the arcing contacts 2 and 5, and is then blasted. The nose end 8 remains connected to the potential-setting contact 13.

It is recommended that the sliding distance of the auxiliary ring of contacts 10 over the nose end 8 is at least 5 millimeters (mm), so as to ensure a satisfactory contact in the closed position of the circuit breaker. The rear portion of the nose end 8 must have a length defined accordingly.

The maximum time period desired between the disconnections of the nose end 8 from the auxiliary ring 10 and then from the first permanent contact 1, is 2 milliseconds (ms), which corresponds to a stroke of about 20 mm between the states in FIGS. 2 and 3, which correspond to these disconnections, for a typical speed of movement of 10 meters per second (m/s) for the movable contacts.

An additional stroke of at least 5 mm is proposed in order to make the connection with the potential-setting contact 13, between the states of FIGS. 3 and 4.

The dielectric spacer 12 is dimensioned to withstand the potential differences that are likely to appear between the second permanent contact 4 and the nose end 8 between the instants at which said nose end 8 leaves the first permanent contact 1 and then touches the potential-setting contact 13.

The operations for closing the circuit breaker take place in reverse manner and do not require any particular comment.

In this description, the first contacts 1 and 2 are said to be stationary, but the invention could be used in circuit breakers or switches in which all of the contacts are movable, or even in which the second contacts 4 and 5 are stationary.

What is claimed is:

1. A circuit breaker or switch comprising a first permanent contact (1) and a first arcing contact (2) and also a second permanent contact (4) and a second arcing contact (5), the second contacts (4, 5) being movable relative to the first contacts (1, 2) in such a manner that, during switching or circuit-breaking movements, the permanent contacts (1, 4) separate from each other before the arcing contacts (2, 5), the second contacts being linear and extending in the direction of the movements, and the second permanent contact (4) being placed between the first permanent contact (1) and the arcing contacts (2, 5), sliding contacts (9, 10), which are stationary relative to the first contacts, being in electrical connection with the second contacts (4, 5), the circuit breaker or switch being characterized in that the second permanent contact (4) includes a nose end (8) directed towards the first contacts (1, 2) and separated from a main portion (11) of the second permanent contact (4) by a spacer (12) that electrically insulates said nose end and said main portion from each other, the sliding contacts are subdivided into a first portion (9) connected to the main portion (11) of the second permanent contact and a second portion (10) connected to the nose end (8) of the second permanent contact, the first permanent contact (1) is suitable for being electrically connected with only the nose end (8) of the second permanent contact (4), and the nose end includes a narrowing step (14) at a front portion, so that, during said switching or circuit-breaking movements, the second portion (10) of the sliding contacts is separated from the nose end (8) before the first permanent contact (1).

2. A circuit breaker according to claim 1, wherein the second contacts are cylindrical, the first arcing contact (2) penetrates into the second arcing contact (5), the second permanent contact (4) penetrates into the first permanent contact (1) in order to establish electrical connections, and the sliding contacts (9, 10) surround the second permanent contact.

3. A circuit breaker according to claim 1, characterized in that the nose end (8) extends to an end of the second arcing contact.

4. A circuit breaker according to claim 1, characterized by a dielectric cap (17) extending between the first permanent contact (1) and the second portion (10) of the sliding contacts.

5. A circuit breaker according to claim 1, characterized in that it comprises a potential-setting contact (13) disposed between the first and second portions (9 and 10) of the sliding contacts, so as to establish an electrical connection with the nose end after the first permanent contact has separated from the second permanent contact during said switching or circuit-breaking movements, and set it to the potential of a terminal (6).

6. A circuit breaker according claim 1, characterized in that the first contacts and the second contacts are all movable in the circuit breaker.

7. A circuit breaker according to claim 1, characterized in that either the first contacts or the second contacts are stationary in the circuit breaker.
